(19) United States
(12) Patent Application Publication
(10) Pub. No.: US 2026/0152039 A1
(43) Pub. Date: Jun. 4, 2026

(54) CONDITIONING DEVICE FOR CONDITIONING AN INTERIOR REGION IN AN INTERIOR OF A CAR

(71) Applicant: MERCEDES-BENZ GROUP AG, Stuttgart (DE)

(72) Inventors: Gudrun SCHÖNHERR, Holzgerlingen (DE); Sven FRIDERICH, Böblingen (DE)

(21) Appl. No.: 19/123,854

(22) PCT Filed: Oct. 9, 2023
(86) PCT No.: PCT/EP2023/077815

§ 371 Date: Apr. 24, 2025

(30) Foreign Application Priority Data
Oct. 25, 2022 (DE) 10 2022 003 965.6

(51) Int. Cl. B60H 1/24

(52) U.S. Cl. CPC B60H 1/246

(57) ABSTRACT

A conditioning device for conditioning an interior region in an interior of a car includes a control unit controlling at least one temperature-control element and a temperature-control surface that can be temperature-controlled by the temperature-control element and is arranged in the immediate vicinity of a facial area of a face of an occupant and is directed towards the facial area. The interior region is formed between the facial area and the temperature-control surface.

### BACKGROUND AND SUMMARY OF THE INVENTION

Exemplary embodiments of the invention relate to a conditioning device for conditioning an interior region in an interior of a car, as well as to a method.

The underlying idea of the present invention relates in particular to maintaining skin moisture or supplying the skin of an occupant in a car with moisture and thus to fulfilling a protective function of the skin, wherein instead of the usual application of skin creams or other agents, the present invention provides for cooling the air directly in the vicinity of the skin, which leads to reduced drying out of the skin. In general, the air in the vehicle is relatively too dry, usually below 40% relative humidity. This can cause the skin to dry out, especially when this relatively too dry air is moved past the skin's surface or the mucous membranes (eye, nose). The dryer the air sweeping past, the more likely it is that moisture will be lost from the skin and/or the mucous membranes.

In other words, the invention specifically promotes the moisturization of the skin, as known from natural cosmetics or from cosmetics, and devices in a car for such an objective are not disclosed in the prior art. Although devices for such cases have been disclosed in the field of cosmetics, such inventions have not yet been disclosed in relation to a car or to a car occupant.

It is known, for example, that the relative humidity in the interior of a car and thus also in an area around the occupant's skin is increased by supplying fresh air. Alternatively, moisture is introduced into the interior directly as a fine mist, thereby making it possible to control the moisture inside the interior. However, no technology is known that uses the effect of cold surfaces near the face, for example, to locally cool the air and thereby freshen the face.

EP 1 338 464 B1 discloses a vehicle seat with a backrest, the padding of which comprises a ventilation layer through which air can flow by means of a fan of a ventilation device, wherein the backrest is provided on its rear with a lining part in which at least one air inlet opening for the ventilation device has recessed. The air inlet opening is arranged in the upper region of the lining part of the backrest and in the region of overlap with the associated fan of the ventilation device, wherein the air inlet opening is concealed by a covering arranged on the lining part.

In addition, DE 20 2019 102 669 U1 also discloses a face mask, for example, through which a fluid can be guided for a cosmetic treatment. DE 10 2020 005 186 A1, on the other hand, describes an aspiration device for respiratory air that is movably attached to a vehicle seat.

The air inside of a car is often significantly dryer than outside the car. An average value for the humidity in Berlin over one year is for example >68% relative humidity (RH). In a vehicle, on the other hand, the maximum relative humidity is 40% on average. The colder the outside temperature, the dryer the relative humidity in the vehicle. In general, the humidity in the vehicle is more likely to be between 15% RH and 30% RH. This is because cold air cannot absorb much moisture. The warmer the air, the more moisture the air can absorb. Therefore, if cold air is heated up, the moisture it contains disperses and is thus diluted, leading to an increasingly lower relative humidity. Conversely, when air cools down, what is known as the dew point is eventually reached. That is the point at which the air reaches the 100% moisture mark and the water it contains is no longer in vapor form. It condenses in the form of clouds and fog. RH values of 40-60% are considered to be comfortable. Values continually below 40% RH cause moisture to be removed from the skin surface and the mucous membranes. Furthermore, it is known that enriching the inhaled air with salt has health benefits, for example in brine therapy or halotherapy. Particularly the surfaces of the face, the eyes and the upper respiratory tract are exposed to this drying effect. This causes unpleasant dryness of the skin, a sensation of sand in the eyes, and increased susceptibility to infection due to the upper respiratory tract mucosa drying out. It would therefore be beneficial to increase the relative humidity, especially in the region of the face, nose, and eyes. Furthermore, enriching the air with salt aerosols is beneficial for the respiratory tract and can reduce susceptibility to infection.

Accordingly, exemplary embodiments of the invention are directed to condition a region around a facial area of a face of an occupant to generate humidity. Advantageous embodiments of the conditioning device are to be regarded as advantageous embodiments for the method and vice versa.

The invention relates to a conditioning device for conditioning a facial area of a face of an occupant in an interior of a car, having a conditioning element adapted to the facial area of the face of the occupant, is held in the vicinity of the facial area by means of a holding device and on which at least one temperature-control element is arranged. In other words, a conditioning device is provided, which is designed to condition an interior region close to the face in the interior of the car. Such an interior region is a region of the interior, which is to say that the interior region is formed in the interior of the car and thus forms a sub-region of the interior. The conditioning device is accordingly designed to condition exactly this interior region, in particular control the temperature therein, i.e., to warm it up or to cool it, wherein a resultant temperature change in the interior region can diffuse into the interior, although it is provided according to the invention to bring at least this interior region to a specified temperature, by cooling and/or by heating. For this, the conditioning device has a control unit for controlling the at least one temperature-control element, wherein the conditioning device is employed in particular for cooling. As temperature-control element, use can be made, for example, of a Peltier element, which as an electrothermal converter can bring about a specified temperature, wherein the temperature-control element is primarily intended to be controlled by a signal from the control unit to reach the specified temperature, in particular also to regulate temperature fluctuations. In addition to a Peltier element, further temperature-control elements with thermoelectric material with a positive efficiency can also be used. The conditioning element has a temperature-control surface that can be conditioned, in particular can be temperature-controlled, by means of the temperature-control element and is arranged in the immediate vicinity of a facial area of a face of an occupant and is directed towards the facial area, with the interior region being formed between the facial area and the temperature-control surface. The term “immediate vicinity” is used to describe a distance between the facial area and the temperature-control surface, which, for example, has a size between >0 cm and 10 cm, in particular between 1 cm and 9 cm, in particular 1.5 cm and 8.5 cm. Therefore, the interior region is defined by the distance between facial area and temperature-control surface and by the size of the surfaces of the facial area and the size of the temperature-control surface. In particular, directed thermal radiation can thus be generated at the specified temperature from the temperature-control surface to the facial area.

In other words, the interior region is to be temperature-controlled, in particular cooled, by means of the temperature-control surface in such a way that humidity is created in this interior region as a result of thermodynamics. In this way, the temperature-control surface of the conditioning element directed towards the face, and for example the forehead, is intended to cool the air in the interior region to the extent that the relative humidity is increased in this region and the removal of moisture from mucous membranes or the skin is generally prevented. Furthermore, as a function of temperature of the temperature-control surface and absolute humidity, the moisture contained in the air can be changed to a fine mist and thereby humidify the face. The misting targets the face and especially the forehead, nose, and mucosa of the eyes and upper respiratory tract. The humidity therefore reaches the occupant's face or respective facial areas of the face directly, thereby increasing the humidity in this facial area or at least partially moisturizing the skin of the face.

In particular, the temperature-control surface is to be set at a specified distance from the facial area so that the best possible level of moisture can be generated. Although it is known that the relative humidity in a car is raised by supplying fresh air, the invention provides for increasing the humidity in a targeted manner and thus directed at the face of the occupant or at the respective facial areas in the interior region. The conditioning device thus uses the effect of the cold surface close to the face to locally cool the air and thus freshen the face. In this case, the temperature-control surface represents the cold surface arranged in the immediate vicinity of the facial area. The design of the conditioning device with the temperature-control surface, or the cold surface provided by the temperature-control surface, can be customized and can be based on an adjustable drying hood from the field of natural cosmetics, for example. The only essential feature is the ability to integrate cold surfaces, preferred by Peltier thermoelectric cooling elements, also known as Peltier thermoelectric cooler modules, which cool the air on the side directed towards the face and, for example, the forehead to the extent that the moisture contained therein moisturizes the face or at least prevents it from drying out. If cooling is to be performed as the temperature control, the thermoelectric temperature-control element must be operated with a current flow intensity defining the intensity of the cooling and therefore the speed and intensity with which the dew point and thus the aim, namely of cooling, is achieved.

The invention thus uses the mechanism that the relative humidity of air increases as the air temperature falls. Humidity is the proportion of gaseous water, i.e., water vapor, contained in the air. The relative humidity in per cent indicates how much water vapor out of a possible maximum is currently present in the air. In contrast to this, the absolute moisture gives information about the actual water vapor content that is currently present in the air, given in g/m³. Air can only absorb a certain amount of water vapor and this amount is strongly dependent on the temperature. Warm air can absorb more water vapor than cold air. This means that warm air is always relatively dryer given the same absolute humidity. If, therefore, air is cooled, the relative proportion of moisture in the air increases. This reduces or even entirely prevents the possible drying-out effect on the skin or the mucous membranes.

One advantageous embodiment of the invention provides that the temperature-control surface can be brought back and forth into the immediate vicinity of the facial area by means of a first actuator that can be controlled by the control unit. A temperature-control surface arranged in front of the face of the occupant would severely impair the occupant's field of view even with an arrangement of openings that the occupant could look through. Therefore it is provided according to the invention to position the temperature-control surface in the immediate vicinity of the facial area only if required. This means that the conditioning device can be adjusted between a use position and a rest position, with the conditioning device, in particular the temperature-control surface being adjusted out of the occupant's field of view in the rest position. For example, the adjustable temperature-control surface can be arranged in a roof area of the car, whereby, when the conditioning device is set in the use position, the temperature-control surface is adjusted into the immediate vicinity of the facial area. Alternative embodiments for adjusting the temperature-control surface towards the facial area are likewise possible, with linear movements primarily being envisaged for a simple adjustment of the conditioning device.

According to one preferred exemplary embodiment, provision is made to change or set a distance between a temperature-control surface of the conditioning element and a facial area of a user as a function of a specified or set temperature value and, optionally, according to the user's wishes. That is to say, the greater the temperature difference between temperature-control surface and vehicle interior, the greater the distance between temperature-control surface and facial area can be set. Therefore, for example, a temperature difference between the temperature to be generated at the temperature-control surface and an interior temperature or interior region of the vehicle interior can be selected as a parameter. Alternatively, a temperature of the facial area of the user can be determined and the temperature difference between the facial area and the temperature-control surface can be taken into account for the distance to be set. Preferably, the distance between the temperature-control surface and the facial area can automatically be set to preferably be larger, or where appropriate smaller, as the temperature difference increases. For example, a user could reduce or increase the automatically set or preset distance, in particular by a performing a manual input. To adapt the distance, it should be possible to adjust the temperature-control surface back and forth from its use position towards the facial area and back again, with the first actuator or the control unit being designed to automatically regulate this distance. In particular, the temperature-control surface is thus adjusted from the use position relative to a preset position towards the facial area. That is to say that the conditioning device is firstly adjusted from the rest position into the use position, in order to then adjust the distance between the user's face and the temperature-control surface more accurately. In addition to the first actuator, for example a sensor device, an optical detection device, or a further device for measuring distance is also arranged on the control unit, by means of which the actuator for controlling the temperature-control surface is controlled in the direction of the facial area. Preferably, after reaching the specified distance, the temperature control is started by the temperature-control element and the humidity increases in the interior region between temperature-control surface and facial area. After the conditioning device has been used, the temperature-control surface is adjusted back and the conditioning device is adjusted into the rest position. This clears the user's field of view again. How the conditioning device is arranged inside the interior of the car can be selected at will, with the movement or adjustment of the temperature-control surface into the immediate vicinity of the face being provided according to the invention. The use of robot arms, telescopic rods, or further may also be incorporated, wherein respective actuators and control units are arranged on the conditioning device or the conditioning device is arranged on movable devices already present in the car.

A further advantageous embodiment of the invention provides that the temperature-control surface can be rotated about its own axis by means of a second actuator that can be controlled by the control unit and can be adjusted by the rotation into the immediate vicinity of the facial area. Regarding the adjustment of the conditioning device from the rest position into the use position, a rotation is a further option for using further degrees of freedom. This means that not only can the temperature-control surface be controlled linearly towards and away from the occupant's face, but also that the surface can be adjusted about a specified axis, so that the generation of the interior region, in which the moisture arises, can be better adapted to the face or better moved towards it from different angles. Therefore, rotation movements and folding movements can be incorporated in the adjustment. In one embodiment of the conditioning device, the temperature-control surfaces are arranged, for example, on a headrest of a car seat on which the occupant is sitting. The temperature-control surfaces are integrated, for example, in lateral side cushions of the headrest, which rotate forwards in the vehicle longitudinal direction relative to the occupant's head by means of a respective actuator and by rotation about a respective axis. As a result, the respective temperature-control surfaces are guided towards the face of the occupant, in particular towards respective facial areas such as cheeks, thereby forming the interior regions to be conditioned. In this example it is especially evident that the temperature-control surface does not have to be embodied as a mask, but that respective temperature-control surfaces can be guided from other regions of the interior to the respective facial areas. For example, it is also possible to adjust the respective temperature-control surfaces from the side cushions of the headrest via respective rails around the user's head, so that the entire face can be covered by the temperature-control surfaces and then temperature-controlled. In this case, the respective temperature-control surfaces have a convex design, for example, and form a semicircle around the user's head as they are moved relative to one another, thereby defining the interior region. In other words, the side brackets having the temperature-control surfaces are to be guided around the occupant's face by corresponding mechanisms and actuators so that different facial areas can be temperature-controlled.

In one further advantageous embodiment of the invention, it is provided that the temperature-control surface has a specified contour corresponding, in particular, to the facial area. This means that the temperature-control surface is not designed as a flat surface, but has at least one contour corresponding to the facial area, which is to say that the surface can have a convex design to allow it to be better adapted to the round contours of the face. In particular, it is also possible, however, to design the entire temperature-control surface in such a way that a contour of a face is imprinted, which can in turn be guided into the immediate vicinity of the face. For example, the temperature-control surface has two openings that can be looked through while the temperature-control surface is placed on the face and is accordingly shaped like a mask. This mask-like temperature-control surface can now be placed on the face by means of the first and the second actuator and can be adjusted back and forth via the respective actuators and also in terms of its angle. For example, however, this temperature-control surface or the contour corresponding to the facial area can be formed from different temperature-control surfaces, which in turn are adapted to the occupant's face when moved in a mutually corresponding manner, so that the interior region in the vicinity of the face can be temperature-controlled. Thus, for example, the respective temperature-control surfaces on both sides of the head or on both sides of the headrest can be pushed in front of the face, thereby making it possible to condition the face. In addition, it is possible to form such a mask-like design of the temperature-control surface by means of 3D printing or also by using a 3D textile knit. In particular, the temperature-control surface can have a coating made from a soft material or substance having a protective effect on the skin when the skin comes into direct contact with the temperature-control surface.

In one further advantageous embodiment of the invention, it is provided that the temperature-control surface has a first wall and a second wall different to the first wall, between which walls a cavity is arranged. In this case, for example, the first wall is temperature-controlled, whereby the second wall at a specified distance from the first wall acts as protection for the user's face, similarly to the coating. By filling the cavity with an agent, it is also possible to bring about temperature insulation, thereby producing a temporally delayed temperature control.

Likewise proven to be advantageous is a further embodiment of the invention in which an aeration device for conditioning the temperature-control surface is arranged in the cavity. In particular, a spacer fabric of the aeration device is arranged in the cavity, through which a temperature-controlled air stream can flow. In other words, the aeration device is used to condition the temperature-control surface and is connected to an air-conditioning unit, for example, in order to convey the air stream through the cavity. The conditioning device has an inlet and outlet in the form of valves or further components for the air stream at the respectively required points arranged corresponding to the connection with the air-conditioning unit. In this regard, the aeration device has, for example, a connection to the air-conditioning unit of the motor vehicle, with the cooling no longer being carried out by a temperature-control element but by the aeration device.

Furthermore advantageous is a further embodiment of the invention in which a signal for adjusting a vehicle seat of the car can be generated by means of the control unit. This means that the control unit sends out a signal into the surrounding area, by means of which the vehicle adjusts the vehicle seat into a specified position, so that the occupant's seat position is adapted when the conditioning device is used. For example, after receiving the signal, the vehicle seat can be reclined while the respective actuators of the conditioning device move the temperature-control surface and/or the temperature-control surfaces towards the occupant's face, whereby the specified interior region is at least partially temperature-controlled. Likewise, not only can the vehicle seat be reclined, but also raised, whereby an arrangement of the conditioning device in, for example, a rear region of the interior roof in the vehicle longitudinal direction can be reached more quickly and whereby no complicated mechanical movements are needed to place the temperature-control surface on the occupant's face. In other words, in this case for example, the conditioning device can be coupled to a driver assistance system to control the vehicle seat.

Likewise advantageous is a further embodiment of the invention in which a plurality of temperature-control surfaces can be temperature-controlled by means of the at least one temperature-control element. In particular, respective temperature-control surfaces are to be equipped with a respective temperature-control element, wherein the respective temperature-control surfaces cover segments of the facial area to be conditioned and thus form a contour. That is to say that the plurality of temperature-control surfaces represent a conditioning mask, wherein the respective temperature-control surfaces can be temperature-controlled by a or respective temperature-control element. As a result, it is possible to cool a plurality of different face shapes or facial areas with the respective temperature-control surfaces or to adapt to these facial areas. In particular, it is possible to adapt to respective occupants of the car, with it being possible to store occupant-dependent pre-settings.

Lastly, it is provided in a further advantageous embodiment of the invention that the control unit is coupled to a driver assistance system of the car for at least semi-automatic use. In this case, for example, an ambience can be employed to audiovisually change an interior design, in which case, for example, when the conditioning device is used, a vehicle seat is reclined, and the light is dimmed and relaxing music is played in order to create a calming atmosphere while the conditioning device is being used. The coupling with the driver assistance system also makes it possible, for example, to provide voice control to use the conditioning device. In particular, a plurality of conformity functions of the conditioning device are to be offered.

In addition, it is provided in one advantageous embodiment of the invention that a sensor device with a temperature sensor is arranged in the conditioning device, in order to determine the temperature in the interior region and to control and regulate the temperature control in accordance with the specifications. In particular, such a sensor device also includes a humidity sensor to calculate the relative humidity. This sensor device can likewise include pollutant sensors and CO₂ sensors or O₂ sensors or ion measurement or salt aerosol detection devices.

A further aspect of the invention relates to a method for operating a conditioning device for conditioning an interior region in an interior of a car. In the method, at least one temperature-control element is controlled by means of a control unit and a temperature-control surface arranged in the immediate vicinity of a facial area of a face of an occupant and directed towards the facial area is temperature-controlled by means of the temperature-control element, wherein the interior region is formed between the facial area and the temperature-control surface. In particular, the temperature-control surface is to be adjusted back and forth into the immediate vicinity of the facial area by means of a first actuator and second actuator that can be controlled by the control unit and rotated about an axis, whereby the conditioning device, in particular the temperature-control surface is adjusted from a rest position into a use position. In this case, the temperature-control surface has, in particular, a specified contour corresponding to the facial area, and a plurality of temperature-control surfaces with respective temperature-control elements can also be arranged to achieve the contour. Furthermore, the conditioning device can be formed with a first wall and a second wall different from the first wall, with a cavity being arranged between the walls. A spacer fabric, which is part of an aeration device in the cavity or encompassing the cavity, can be placed in this cavity. In particular, the aeration device is used instead of the temperature-control element for conditioning the temperature-control surface and is coupled to an air-conditioning unit of the car. The control unit is also designed to generate a signal to adjust a vehicle seat of the car or to be coupled to a driver assistance system of the car for at least semi-automatic use of the driver assistance system. Further method steps for operating further embodiments of the conditioning device can be included in the method.

In other words, it should be possible to at least partially moisturize a face of an occupant. For this purpose, the invention is to have a temperature-control surface or a temperature-control surface with a specified contour, for example also a hood or a hood-like structure, which is arranged at a defined distance from the driver's face or a facial area of the occupant and also roughly imitates this facial contour, so that a defined distance from the eyes and nose, namely the immediate distance, is maintained. It is possible to use a plurality of temperature-control surfaces for this purpose, which also in turn can be arranged around the face to give this contour. By means of such a hood or by means of such a contour, also formed by 3D printing, for example, or also by using a 3D textile knit, it is possible to condition the facial area of the occupant's face or to condition the interior region between the facial area and the temperature-control surface. In this case it is likewise possible to create a double wall through which air can be conditioned, which in turn can be directed via an aeration device between the walls or directly to the temperature-control surface. Such a conditioning device or the temperature-control surface can, for example, be fastened on an upper side of a backrest or on a headrest and if required pulled in front of the face and also moved away again. In particular, in this case the conditioning device has the respective actuators, by means of which it can be adjusted back and forth and also rotated about an axis. Various mechanisms are however likewise possible here to enable flexible use, for example by folding, folding away, pivoting away or by fully automatic or manual movement of the temperature-control surface. In particular, conditioning is provided for here, with heating and cooling being possible, in particular cooling, as well as the enrichment of the facial area or the interior region with plant or salt aerosols, whereby enrichment with oxygen or ionization is also made possible.

Furthermore, it is possible by means of the conditioning device to provide more or less space between the face and the temperature-control surface, whereby the air quality in this area below the temperature-control surface is brought into a positive range and whereby exhaled air can also readily escape. Central to the invention is, however, a mechanism for reducing the surface temperature of that side of the temperature-control surface that is directed towards the face, with the aim of reducing the temperature of the air between the temperature-control surface and the face. For the relative decrease in the surface temperature, a Peltier element can be used in this case as the temperature-control element, which is arranged on the temperature-control surface and which passes on the generated heat or cold to the temperature-control surface. A material for the temperature-control surface can be selected in such a way that cold is transferred. In other words, the temperature-control surface is formed by means of a cold-and heat-permeable material. In particular, it is also possible to install a cold-conducting material or a yarn through the choice of material of the 3D print, to make it possible to conduct the temperature. In addition, a heating filament can also be introduced or imprinted, thereby making it possible in particular to increase the temperature in the facial area.

Alternatively, the temperature-control surface can be designed as a 3D knit in the sense of a spacer fabric, through which, by means of a fan of a ventilation device or of the aeration device, air is moved through the ventilation layer. At least one air inlet opening is provided for this purpose, for example at the contact surface with the hood and for example on an upper part of the backrest of the vehicle seat. Such a transition point is clad with a lining part and is provided, in particular, to provide an air inlet opening. It is also possible to arrange a low-pressure ventilator with, for example, a radial fan, by means of which the air can be moved into the air inlet opening, after which it moves through the ventilation layer. To enrich the air in the facial area under the hood with salt aerosol, for example the air stream can be admixed with a salt aerosol in which salt is kept as a solid in an air-permeable container as an obstacle in the air stream and is thus admixed with the air stream. This is likewise possible when using plant aerosols; for example, lavender blossom can be applied in such a way that it is introduced into the air stream on an air-permeable non-woven fabric. In other words, the object of the invention is to provide a conditioning device or a control unit for controlling the interaction of the components for the cooling, ventilation or heating as a function of the air temperature and humidity. Objectives can be, for example, cooling the surface of the face as well as heating the facial area. It is also provided to regulate a relative humidity of the inhaled air and to increase the relative humidity in the air around the eyes. Lastly, it is also provided to increase moisture on the facial area. For every objective, a respective algorithm is saved in the control unit or on the conditioning device, thereby controlling the interaction between the sensors and actuators. So that the occupant can select these objectives, it must be possible to select the options and define successive objectives through a form of user interaction, for example by means of the driver assistance system. Alternatively, these are defined and encoded by numbers or by names in such a way that the occupant knows exactly which functions they use. Alternatively, the form and duration of the objectives can be prepared via an application on an external mobile data device or on an external input medium or on a smartphone.

Lastly, the conditioning device is designed in such a way that it is provided with further possible uses through the addition of materials or material layers. For example, an acoustic layer could be overlaid to block sound, to further optimize personal privacy and quiet zones. In addition, it is likewise possible to add or incorporate a layer at certain points on the inside to remove breathing sounds.

Further advantages, features and details of the invention will become apparent from the following description of preferred exemplary embodiments and with reference to the drawings. The features and feature combinations mentioned above in the description and the features and feature combinations mentioned hereinbelow in the description of the figures and/or shown on their own in the figures can be used not only in the respectively combination, but also in other combinations or in isolation, without departing from the scope of the invention.

### BRIEF DESCRIPTION OF THE DRAWING FIGURES

The figures show:

FIG. 1 a perspective view of an embodiment of a conditioning device according to the invention in an interior of a car; and

FIG. 2 a side view of an occupant located inside the interior during use of an embodiment of the conditioning device according to the invention.

### DETAILED DESCRIPTION

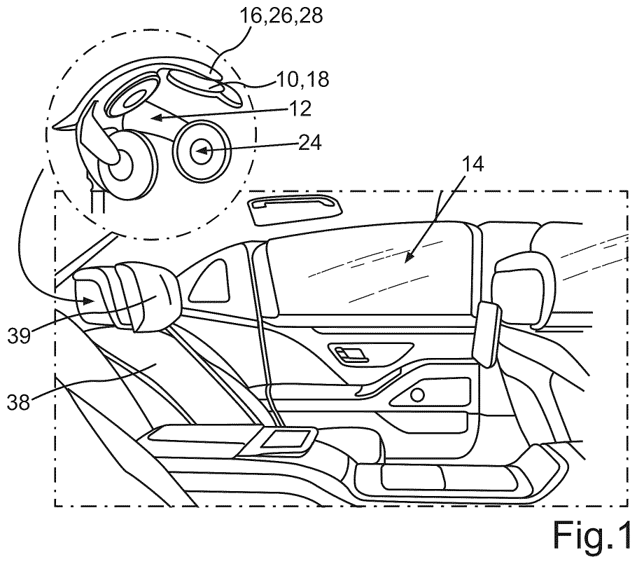

FIG. 1 shows a perspective view of an embodiment of a conditioning device 10 according to the invention for conditioning an interior region 12 in an interior 14 or passenger compartment of a car. This conditioning device 10 has a control unit 16 (not shown in more detail) for controlling at least one temperature-control element 18 (not shown) and a temperature-control surface 24 that can be temperature-controlled by means of the temperature-control element 18 and is directed towards a facial area 20 of a face of an occupant 22 or user. The temperature-control surface 24 is formed on a shaped or contoured conditioning element and is directed towards a user 22. The interior region 12 is formed in this case between the facial area 20 and the temperature-control surface 24 and in the immediate vicinity of the facial area 20.

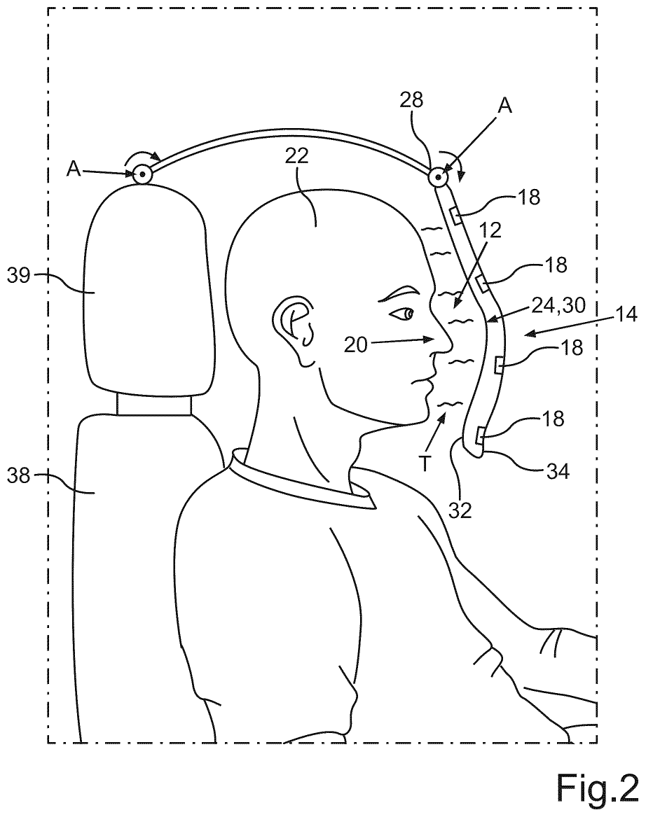

Here, the conditioning device 10 is shown simplified in one embodiment, which in particular has the temperature-control surface 24, which can be adjusted back and forth, in particular linearly, by means of a first actuator 26, controllable by the control unit 16 and not shown in more detail, and which can be rotated by means of a second actuator 28 that can be controlled by the control unit 16 about an axis A illustrated in FIG. 2. In other words, the conditioning device 10 with its conditioning element for conditioning an interior region 12 in the immediate vicinity of the facial area 20 is adjusted towards the face the occupant 22 and used to condition the interior region 12, wherein the temperature-control surface 24 is guided towards the face of the occupant 22 by means of the control unit 16 by means of the actuators 26, 28. How the conditioning device 10 is arranged inside the interior 14 the car can be chosen at will, but the movement or adjustment of the temperature-control surface 24 into the immediate vicinity of the face is provided for. In this case, the use of robot arms, telescopic bars, or the like can also be provided for, wherein the respective actuators 26, 28 and control unit 16 are arranged on the conditioning device 10 or the conditioning device 10 is arranged on movable devices that are already present in the car. It is provided in this case to raise the relative humidity in the interior region 12, i.e., in a region around the occupant's facial skin.

FIG. 2 shows a side view of an occupant 22 located inside the interior during use of an embodiment of the conditioning device 10 according to the invention. The conditioning device 10 for conditioning the interior region 12 in the interior 14 of the car is designed to condition, in particular to cool, the interior region 12 at the facial area 20 of the face of the occupant 22 to generate humidity, in order to thus humidify the skin of the occupant 22 in the facial area.

The interior region 12 is a region of the interior 14, that is to say that the interior region 12 is formed in the interior 14 of the car. The conditioning device 10 is accordingly designed to condition precisely this interior region 12, i.e., to heat it up or cool it, whereby a resultant temperature change in the interior region 12 can diffuse into the interior 14, although it is provided to bring at least this interior region 12 to a specified temperature T, by cooling and/or by heating. For this purpose, the conditioning device 10 has the control unit 16 for controlling the at least one temperature-control element 18, wherein the conditioning device 10 is employed in particular for cooling. As temperature-control element 18, use can be made here, for example, of a Peltier element, which as an electrothermal converter can bring about a specified temperature T, wherein the temperature-control element 18 is primarily intended to be controlled by a signal from the control unit 16 to reach the specified temperature T, in particular also to regulate temperature fluctuations.

The conditioning device 10 has the temperature-control surface 24 that can be temperature-controlled by means of the temperature-control element 18 and is arranged in the immediate vicinity of the facial area 20 and directed towards the facial area 20, wherein the interior region 12 is arranged between the facial area 20 and the temperature-control surface 18. The term “immediate vicinity” is used to describe a distance between the facial area 20 and the temperature-control surface 18, which has a size between >0 cm and 10 cm, in particular between 1 cm and 9 cm, in particular 1.5 cm and 8.5 cm. Thus, the interior region 12 is defined by the distance between facial area 20 and the temperature-control surface 24 and by the size of the surfaces of the facial area 20 and the size of the temperature-control surface 24. The distance between the temperature-control surface 24 of the conditioning element and the facial area 20 of a user 22 can be changed or set as a function of a specified or set temperature value at the temperature-control surface 24 and, optionally, according to the user's wishes. That is to say, the greater the temperature difference between temperature-control surface 24 and interior region 12 or interior 14 of the vehicle or car, the greater the distance between temperature-control surface 24 and facial area 20 can be set, preferably automatically; therefore, for example, a temperature difference between the temperature to be generated at the temperature-control surface 24 and an interior temperature of the vehicle interior (interior region 12 and/or interior 14) can be selected as a parameter. The distance between temperature-control surface 24 and facial area 20 is preferably set or regulated by the first actuator 26 with the control unit 16 and at least one temperature sensor (not shown).

The interior region 12 lies between the facial area 20 of the face of the occupant 22 and the temperature-control surface 24 directed towards the face. The temperature-control surface 24 is designed here in such a way that a specified contour corresponding to the facial area 20 is mapped. This contour 30 is constructed, in particular, in a manner corresponding to the facial area 10, that is to say that the distances of the temperature-control surface 24 from the face of the occupant 22 are as equal as possible, also to the nose, mouth, eye sockets, forehead and so on. In addition, the conditioning element has a first wall 32 and a second wall 34 at a distance therefrom, so that there is a cavity in between, in which for example a spacer fabric or a temperature-control means can be arranged. The respective temperature-control elements 18 are also, for example, arranged on the second wall 34 and the first wall 32 has, for example, a protective layer made of a textile, which protects against direct contact of the face with the temperature-control surface 24. It is likewise possible to arrange an aeration device 36 for conditioning the temperature-control surface 24 between the two walls 32, 34, wherein the aeration device 36 can be coupled for example to an air-conditioning unit, which in turn has an opening on a headrest 39 of the vehicle seat 38, which is not shown, however.

It is likewise possible, by means of the control unit 16, to provide a signal to adjust the vehicle seat 38 and to adjust the headrest 39, whereby the vehicle seat 38 can be raised as well as reclined, for example. On use of the conditioning device 10, this makes it possible to provide a relaxed position for the occupant 22 when they are using the conditioning device 10. It is likewise possible to design the conditioning device 10 with a plurality of temperature-control surfaces 24, wherein respective temperature-control elements 18 can be arranged; however, it is likewise possible to use the aeration device 36, for example, to enable the temperature control of the respective temperature-control surfaces 24 by means of an individual temperature-control element 18. Lastly, the control unit 16 is coupled to a driver assistance system of the car for at least semi-automatic use, whereby an ambience or an auditory and visual interior design of the interior 14 of the car can be customized when the conditioning device 10 is in use.

The conditioning device 10 is operated by means of a method according to the invention, in which the control unit 16 is used to control the at least one temperature-control element 18 for conditioning the interior region 12. In the method, the temperature-control surface 24, which is arranged in the immediate vicinity of the facial area 20 and is directed towards the facial area 20, is also temperature-controlled by means of the temperature-control element 18, wherein the interior region 12 is arranged between the facial area 20 and the temperature-control surface 24. In particular, the temperature-control surface 24 is to be adjusted back and forth into the immediate vicinity of the facial area 20 by means of the actuators 26, 28, controllable by the control unit 16, and rotated about an axis A, whereby the conditioning device 10, in particular the temperature-control surface 24 is adjusted from a rest position into a use position. In this case, the temperature-control surface 24 has, in particular, the specified contour 30 corresponding to the facial area 20, and in order to achieve the contour 30, a plurality of temperature-control surfaces 24 with respective temperature-control elements 18 can also be arranged.

In summary, the conditioning device 10 constitutes an alternative device for a facial humidifying hood for humidifying the facial area 20 of the occupant 22 in a car.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-11. (canceled)

12. A conditioning device configured to condition a facial area of a face of an occupant in an interior of a car, the conditioning device comprising:
a conditioning element adapted to the facial area of the face of the occupant;
a holding device; and
a temperature-control surface held in a vicinity of the facial area by the holding device; and
at least one temperature-control element arranged on the temperature-control surface.

13. The conditioning device of claim 12, further comprising:
a first actuator configured to adjust, under control by a control unit, the conditioning element back and forth into the vicinity of the facial area.

14. The conditioning device of claim 12, wherein a distance between the temperature-control surface and a facial area of a user is automatically settable as a function of a specified or set temperature value.

15. The conditioning device of claim 14, further comprising:
a second actuator configured to rotate the conditioning element about its own axis, wherein the second actuator is controlled by a control unit and is adjustable by the rotation into the vicinity of the facial area.

16. The conditioning device of claim 12, wherein the conditioning element has a specified contour.

17. The conditioning device of claim 12, wherein the conditioning element has a first wall and a second wall spaced apart from the first wall, wherein a cavity is formed between the first and second walls.

18. The conditioning device of claim 17, further comprising:
an aeration device arranged in the cavity and configured to condition the conditioning element.

19. The conditioning device of claim 12, wherein a control unit is configured to generate a signal for to adjust a vehicle seat of the car.

20. The conditioning device of claim 12, wherein the conditioning element comprises a plurality of conditioning elements and the at least one temperature-control element comprises a plurality of temperature-control elements configured to be temperature-controlled a respective one of the plurality of conditioning elements.

21. The conditioning device of claim 12, wherein a control unit is coupled to a driver assistance system of the car for at least semi-automatic use of the conditioning device.

22. A method comprising:
moving a conditioning device, which includes a conditioning element adapted to a facial area of an occupant in an interior of a car, so that a temperature-control surface of the conditioning device is held in a vicinity of the facial area of the occupant; and
conditioning, by the conditioning device, a face of the occupant using at least one temperature-control element arranged on the temperature-control surface.
